(19) United States
(12) Patent Application Publication
(10) Pub. No.: US 2015/0359347 A1
(43) Pub. Date: Dec. 17, 2015

(54) ZONED TEMPERATURE REGULATING BEDDING PRODUCT AND METHOD OF FORMING SAME

(71) Applicant: Innocor, Inc,, West Long Branch, NJ (US)

(72) Inventor: Michael Loomis, Holmdel, NJ (US)

(21) Appl. No.: 14/742,053

(22) Filed: Jun. 17, 2015

Related U.S. Application Data
(60) Provisional application No. 62/013,169, filed on Jun. 17, 2014.

(51) Int. Cl. A47C 21/04; A47C 31/10; A47C 27/14; A47C 27/15; B29C 59/04; B05D 1/28

(52) U.S. Cl. CPC A47C 21/04; B29C 59/04; B05D 1/28; A47C 27/146; A47C 27/15; A47C 31/10; B29L 2031/58

(57) ABSTRACT

This document relates to a zoned temperature regulated bedding product. Some embodiments of the present disclosure are directed to a bedding product that includes a support layer, which includes temperature regulating material such as gel or gel foam and substrate material such as memory foam, where the temperature regulating material is arranged into temperature regulating zones along the surface of the support layer.

### RELATED APPLICATIONS AND CLAIM OF PRIORITY

This patent document claims priority to U.S. Provisional Patent Application No. 62/013,169, filed Jun. 17, 2014, the disclosure of which is fully incorporated by reference into this document.

### BACKGROUND

The body temperature of people who are sleeping varies greatly. Most people tend to sleep “hot” where they feel that their body or surface skin temperature is too high, while other people tend to sleep “cold”. This makes the sleeper uncomfortable which leads to longer periods of time to fall asleep and more awakenings. As such, there is a need for bedding products that regulate the temperature of people while using the product.

### SUMMARY

In an embodiment, a temperature regulating bedding product includes a support layer comprising substrate material having a plurality of peaks and valleys arranged thereon. The product also includes temperature regulating material disposed on the peaks or valleys in one or more temperature regulating zones along an upper surface of the support layer. Areas of the support layer that do not correspond to temperature regulating zones are free from the temperature regulating material, or have an applied amount the temperature regulating material that is less than the amount applied to the temperature regulating zones.

In some embodiments, the temperature regulating material comprises gel or gel foam. In some embodiments, the substrate material of the support layer may comprise conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam, or combinations thereof.

The temperature regulating zones may be positioned so that the temperature regulating zones coming into contact with at least one, but less than all, of the following parts of the body of a typical human user during use: head/neck, shoulders, waist, hips, and legs/feet. The temperature regulating zones may include raised sections having peaks that comprise the temperature regulating material, and valleys that are free from the temperature regulating material. Alternatively, the temperature regulating zones may comprise channels formed into the support layer and at least partially filled with the temperature regulating material.

In another embodiment, a method for fabricating a bedding product with a zoned temperature regulating system includes: providing a support layer comprising a foam substrate material; forming a plurality of peaks and valleys into the support layer so that the peaks and valleys are selectively arranged in temperature regulating zones; and dispersing temperature regulating material onto the peaks or valleys of one or more of the temperature regulating zones along an upper surface of the support layer so that areas of the support layer that do not correspond to temperature regulating zones are either free from the temperature regulating material or have a lesser amount the temperature regulating material applied thereto.

Optionally, forming the peaks and valleys into the support layer may include using a convoluter having a blade and a set of patterned rollers. The convoluter will draw the support layer across the blade to split the support layer, and it will use the patterned rollers to impart the peaks and valleys on the support layer. Alternatively, the peaks and valleys may be formed by a compression cutter that compresses the support layer against a board that bears a pattern to form peaks and valleys in the support layer and that cuts material from the support layer in compressed sections of the support layer.

In some embodiments, dispersing the temperature regulating material includes using a roll coating device. If so, then one or more support rollers of the roll coater may draw the support layer between an applicator roller and the support roller(s) so that the applicator roller applies the temperature regulating material to the peaks of one or more of the temperature regulating zones but does not apply the temperature regulating material to the valleys of the temperature regulating zones. The applicator roller may contact the peaks when the temperature regulating zones pass through a gap between the applicator roller and the support rollers. When a portion of the support layer that does not include a temperature regulating zone passes through the gap, the applicator roller is moved away from the support rollers to expand the gap so that the applicator roller does not contact the portion of the support layer that does not include a temperature regulating zone.

In another embodiment, a method for fabricating a bedding product with a zoned temperature regulating system includes providing a support layer comprising a foam substrate material, forming a plurality of peaks and valleys into the support layer, and using a roll coating device, to dispersing temperature regulating material onto the peaks or valleys of one or more temperature regulating zones along an upper surface of the support layer. In this way, areas of the support layer that do not correspond to temperature regulating zones will be free from the temperature regulating material, or the non-temperature regulating zones will have a lesser amount the temperature regulating material than will the temperature regulating zones.

In this embodiment, dispersing the temperature regulating material may include using one or more support rollers of the roll coating device to draw the support layer between an applicator roller and the support roller(s) so that the applicator roller applies the temperature regulating material to the peaks of one or more of the temperature regulating zones but does not apply the temperature regulating material to the valleys of the temperature regulating zones.

In various embodiments, the applicator roller also may be operated and positioned to cause the gap to have a first size when a first one of the temperature regulating zones passes through the gap, and a second size when a second one of the temperature regulating zones passes through the gap, wherein the second size is larger than the first size but the applicator roller will still contact the peaks when the second temperature regulating zone passes through the gap. In this and certain other embodiments, the first temperature regulating zone may correspond to a head/neck area or a waist area of the support layer, and the second temperature regulating zone may correspond to a legs/feet area of support layer.

### BRIEF DESCRIPTION OF THE DRAWINGS

FIG. 1 illustrates a bedding product with temperature regulating zones that are arranged in optimal areas of the support layer.

FIG. 2 illustrates steps of various processes of applying a temperature regulating material to a foam substrate.

FIG. 3 illustrates the result of passing a foam substrate through a convoluter.

FIG. 4 illustrates an example of how temperature regulating material may be applied to the foam substrate of FIG. 3.

FIG. 5 illustrates various zones of an example of a bedding product.

FIG. 6 illustrates a bedding product having a support layer, with raised sections added to the support layer, substrate material distributed throughout the support layer, and temperature regulating material distributed on the raised sections.

FIG. 7 illustrates a bedding product having a support layer, with channels formed into the support layer, substrate material distributed throughout the support layer, and temperature regulating material distributed throughout the channels.

### DETAILED DESCRIPTION

This document is not limited to the particular processes, compositions, or methodologies described, as these may vary. The technology used in the description is for the purpose of describing the particular versions or embodiments only, and it is not intended to limit the scope of the present invention which will be limited only by the appended claims. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

As used in this document, the singular forms “a”, “an”, and “the” include plural references unless the context clearly dictates otherwise. Thus, for example, reference to a “foam” is a reference to one or more foams and equivalents thereof known to those skilled in the art, and so forth.

As used in this document, the term “about” means plus or minus 10% of the numerical value of the number with which it is being used. Therefore, about 50% means in the range of 45% to 55%.

As used in this document, the term “comprises” or “comprising” means includes at least the following but does not exclude others.

As used in this document, the term “bedding product” includes, without limitation, mattresses, pillows, mattress toppers, seat cushions and any product intended to support at least part of a person. It also includes similar items made of foam such as that used in mattresses and pillows, such as lumbar supports, back supports, gaming chairs, ottomans, chair pads, benches and seats.

The term “dispersed” or “dispersing” as used in this document includes distributed, spread, immersed, embedded, saturated, deposited, disseminated, scattered, diffused, infused, interspersed, encapsulated or the like.

The term “roll-coat” or “roll-coating” as used in this document refers to a process that uses a set of roller applicators to apply and distribute temperature controlling material on the surface of the bedding product. This process includes placing the temperature controlling material on a flat surface, positioning the roller applicators at a starting point on the bedding product, and rolling the roller applicators across all or a portion of the surface of the bedding product, thereby applying the temperature controlling material to the surface of the bedding product.

As used in this document, the term “optimal area” or “optimal areas” means any area of the surface of the bedding product that has a location that is expected to come into contact with certain specific body parts of a typical person using the bedding product during typical use. A typical person may be deemed to be a person of average size for the product. For a product designed for a child, the average size may be an average size of a child of the age range for whom the product is designed. “Optimal” does not necessarily mean “best” or “exclusive.”

The term “foam” as used in this document refers to any type of air filled matrix structures including, without limitation, conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam such as that disclosed in U.S. Patent Application Publication No. 2005/0278852, which is hereby incorporated by reference, or combinations thereof. In some embodiments, the foam may be hyper-soft high airflow viscoelastic foam. In particular embodiments, the foam may be viscoelastic polyurethane foam or memory foam. Memory foam is generally temperature-sensitive, so environmental temperatures or a user's body heat may affect how the foam feels. For example, memory foam responds to a user's body heat and molds around the user, thus the foam may aid in relieving pressure points, preventing pressure sores, improving circulation and the like. Higher density memory foam may mold to a warm human body in a few minutes.

In particular embodiments, the foam may be polyurethane foam created from a formulation comprising an isocyanate, a surfactant, and a polyol blend comprising a vegetable oil polyol as described in U.S. Pat. No. 7,700,661, which is hereby incorporated by reference. In further embodiments, the polyurethane foam may be made from a formulation comprising a polyol blend comprising a petrochemical polyol and a vegetable oil polyol, and an isocyanate blend comprising a 2,4 toluene diisocyanate (TDI) isomer and a 2,6 TDI isomer, wherein the ratio of petrochemical polyol to vegetable oil polyol in the polyol blend is about equal to the ratio of the 2,4 TDI isomer to the 2,6 TDI isomer in the isocyanate blend, as described in U.S. Pat. No. 7,700,661. In some embodiments, the foam may further include additives such as, without limitation, activators, stabilizers, amines, colorants, dyes, pigments, chain-extending agents, surface-active agents (i.e., surfactants), fillers, and the like.

As used in this document, “temperature regulating material” refers to substances that may either cool or heat the skin of a person who is touching a product containing the material. Temperature regulating material includes, but is not limited to, “gel” or “gel-foam.” The term “gel-foam” as used in this document means a foam comprising gel particles dispersed within. The term “gel” as used in this document means any liquid-extended polymer composition. A gel, when it comes in contact with a human body, can help cool the contacted area. In some aspects, the gel composition may contain a three-dimensional network of cross-linked molecular chains (gels), or it may merely behave as if it contained such a network (gelloids). The gel of embodiments described in this document may be any liquid-extended polymer or gelatinous composition having a molecular weight and durometer characteristics that allow the gel to deform under load of a typical human, while having a resilience that allows it to rebound into its original shape quickly, such as within one second or less, when the load is removed. Examples of gels that may be used in aspects of the invention include, without limitation, oil-extended triblock copolymer compositions such as that disclosed in U.S. Pat. No. 3,485,787; U.S. Pat. No. 3,676,387; U.S. Pat. No. 3,827,999; U.S. Pat. No. 4,176,240; U.S. Pat. No. 4,259,540; U.S. Pat. No. 4,351,913; U.S. Pat. No. 4,432,607; U.S. Pat. No. 4,492,428; U.S. Pat. No. 4,497,538; U.S. Pat. No. 4,509,821; U.S. Pat. No. 4,709,982; U.S. Pat. No. 4,716,183; U.S. Pat. No. 4,833,193; U.S. Pat. No. 4,942,270; U.S. Pat. No. 5,149,736; U.S. Pat. No.5,331,036; and U.S. Pat. No. 5,994,450, and thermoplastic elastomer gelatinous compositions such as that disclosed in U.S. Pat. No. 4,369,284; U.S. Pat. No. 4,618,213; U.S. Pat. No. 5,262,468; U.S. Pat. No. 5,508,334; U.S. Pat. No. 5,153,254; U.S. Pat. No. 5,334,646; U.S. Pat. No. 5,239,273; U.S. Pat. No. 5,475,890; and U.S. Pat. No. 5,336,708. Each of the above references is hereby incorporated by reference.

Gel-foams may be made by blending a gel (which would be in particle form, optionally encapsulated with a material to preserve the integrity of the gel while it is suspended in the foam) with a polyol to form a blend. In an alternate embodiment, the gel may be encapsulated before being blended with the polyol. Compositions used for encapsulating the gel may comprise polyol, fabric, plastic, elastomers, thermoplastic materials, or the like. The gel particles may be dispersed and suspended throughout the foam composition.

In some embodiments, a foamed gel may be made by pouring a gel into a mold, mixing in a blowing agent into the gel. Examples of blowing agents include isocyanate, water, nitrogen-based materials, sodium bicarbonate, hydrocarbons, carbon dioxide, or the like.

This document relates to a zoned temperature regulated bedding product. Some embodiments of the present disclosure are directed to a bedding product that includes a support layer, which includes temperature regulating material such as gel or gel foam and substrate material such as memory foam, where the temperature regulating material is arranged into temperature regulating zones along the surface of the support layer.

In a particular embodiment, the temperature regulating material is gel or gel foam, and the substrate material is selected either conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam, or any combination thereof.

In a more particular embodiment, the temperature regulating zones are concentrated in optimal areas of the surface of the support layer, resulting in the temperature regulating zones coming into contact with parts of the body, including the head, torso, buttocks, legs, feet, or any combination thereof.

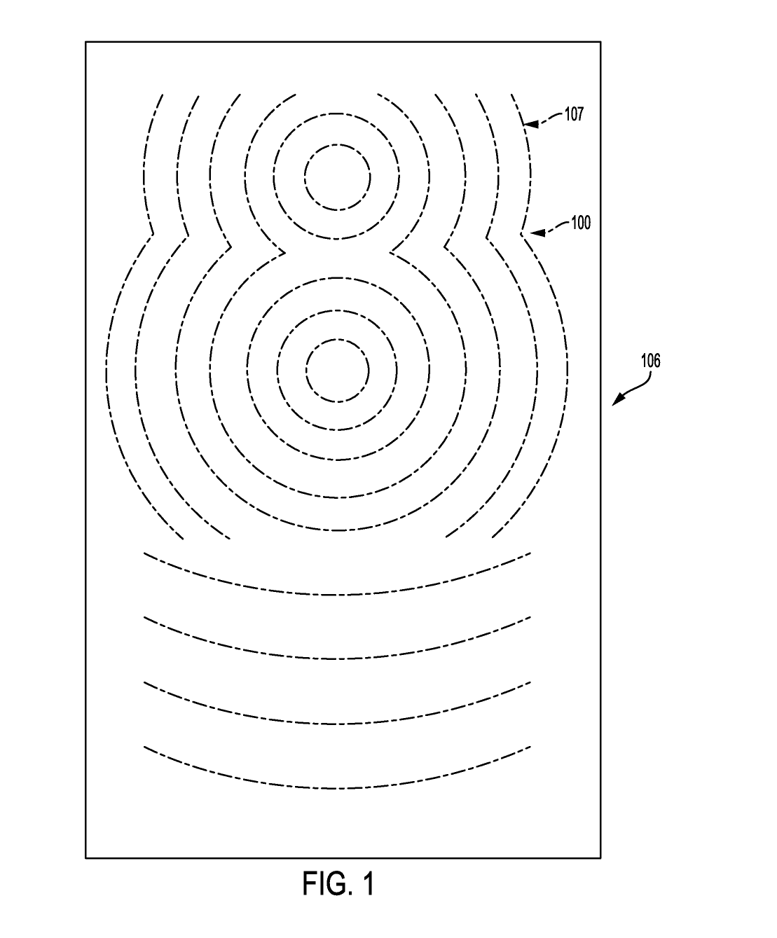

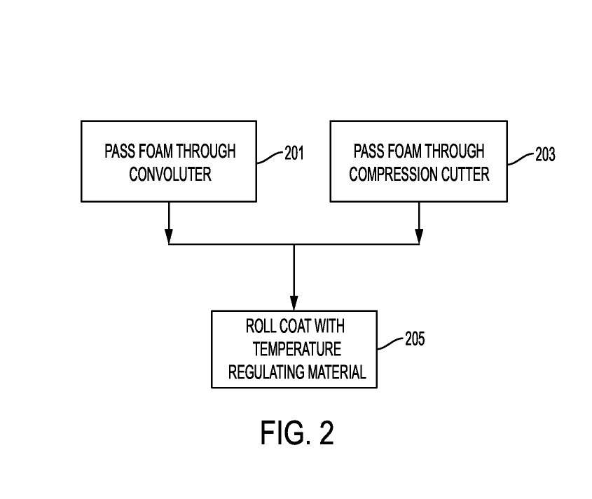

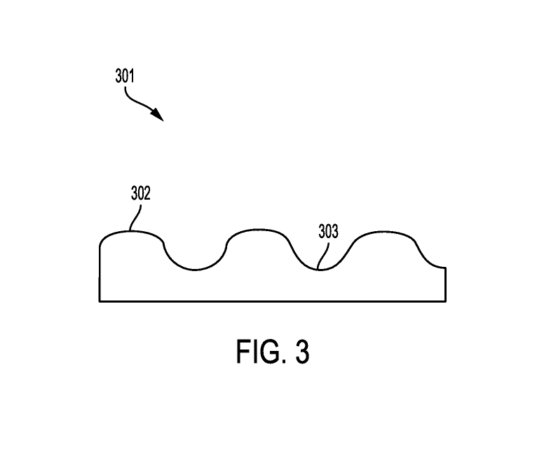

FIG. 1 illustrates an example of temperature regulating zones 107 concentrated in optimal areas on the surface of the support layer 100. In this illustration, the temperature regulating zones 107 are arranged on the surface of the bedding product 106, allowing the temperature regulating zones 107 to come into contact with certain body parts of the bedding product user, such as the head, torso, buttocks, legs, feet, or any combination thereof. By focusing the temperature regulating zones only in those strategic areas, the process of dispersing the temperature regulating material to these zones will focus only on areas where the material is most required, and will use less temperature regulating material on unnecessary areas. The temperature regulating zones are formed with a set of raised areas, for which a method of forming will be discussed below in the description associated with FIGS. 2 and 3

There are various ways to apply the temperature regulating material to the bedding product. In a particular embodiment, the temperature regulating zones comprise raised sections coated with temperature regulating material. The raised sections comprise portions of substrate material that are raised above or extend away from a surface of the substrate material. For example, the temperature regulating material may be applied to the raised sections using a roll-coating process. Temperature regulating material may be dispersed into the raised sections utilizing a variety of techniques or processes as is known in the art (e.g., as an additive or component or the like during any stage of manufacturing the bedding product), such as roll-coating, etc. Optionally, the temperature regulating material may bond to and/or disperse before the foam cures so that a portion of the temperature regulating material also disperses within the support layer. The material may be absorbed and bond within the open cells of the substrate or support material during the application. In some embodiments, the substrate material should be fully cured prior to application of the temperature regulating material. The roll-coating and other application processes may be done in a way that focuses the temperature regulating material on mostly or only the upper surface of the raised sections. This process includes placing the temperature controlling material on a roller apparatus, or otherwise applying the temperature controlling material to the surface, placing the roller apparatus on one edge of the bedding product, and rolling the roller apparatus across some or all of the surface of the bedding product, thereby applying the temperature controlling material to the raised areas without applying the temperature controlling material to the full non-raised surface of the bedding product.

In another particular embodiment, the temperature regulating zones include raised sections filled with or formed of temperature regulating material. In this embodiment, the surface of the support layer of the bedding product is covered with raised sections comprised of temperature regulating material, similar to laying a gel strip or other raised pattern on top of a flat surface. The raised sections may be formed by molding substrate material into sections that are raised above the support layer. Raised sections may also be produced by gluing or otherwise adhering pieces to the substrate.

The raised sections may also be formed by surface modification of the foam substrate, such as by compression cutting or convoluting. FIG. 2 illustrates a process by which a raised pattern may be formed in temperature regulating zones using convoluting and compression cutting. The convoluting process 201 may include feeding a slab of foam (such as flexible polyurethane, bonded/combined or memory foam) through a convoluter, which includes a set of patterned rollers and a blade that cuts the foam to produce two identical parts. The convoluter draws the foam across its blade in a generally horizontal direction to form two surfaces at the location where the foam splits. The studs of the patterned rollers apply pressure to the foam as the blade splits the compressed foam. The rollers each set at a constant throughput speed (such as up to 65′/min, or another speed that is appropriate for the material) and identical spacing from the blade. The closer the rollers are to the blade, the deeper the valley of the patterns in the foam. The rollers can be removed and replaced with stud patterns that will produce the desired patterns and spacing in the foam.

Alternatively, in a compression cutting process 203, a sheet of foam being compressed against a machined board that bears a desired pattern. The pattern will create the desired peaks and/or valleys in the temperature regulating zones of the foam, as described above. The material running through the equipment will be pressed onto the pattern, as a blade cuts out the compressed sections. This will create a bedding product with the peaks and valleys of the desired pattern.

The end result of both operations is a patterned foam sheet 301 with peak 302 and valley 303 areas, as shown by way of example in FIG. 3. Patterns will vary in size and shape to achieve optimal pressure relief and comfort.

The height and width of the raised sections may vary. For example, the height of any of the raised sections is about 0.25 inch to about 1 inch above the support layer's primary surface. In another particular embodiment, the height of the raised sections is about 0.25 inch, about 0.4 inches, about 0.5 inches, about 0.75 inches or about 1 inch. In another particular embodiment, the height of the raised sections may be any fraction of an inch above the support layer's primary surface. Other heights are possible.

In a particular embodiment, the width of any or all of the raised sections may be about 1 inch to about 5 inches. In another particular embodiment, the width of the raised sections is about 1 inch, about 2 inches, 3 inches, about 4 inches or about 5 inches. Other widths are possible. The widths may vary based on the type of temperature change that the product is designed to target. Wider widths may allow more temperature regulating material to be distributed to the substrate in those areas. A single bedding product may have raised sections of various widths in order to provide multiple, varied thermal patterns in body-contacting surface of the bedding product.

Returning to FIG. 2, once the desired pattern is created, the patterned foam sheet may be roll coated 205 or otherwise enhanced with the temperature regulating material. In this process, the roll applicators will be set at a distance from the foam surface that coats only the peak sections of the foam and avoids filling the valley sections. (Although an insignificant amount of the temperature regulating material may fall into the valleys, most of the material will remain on the peaks.) The roll coating device will include a height adjustment setting that permits an operator or an external processing device to command it to be adjusted based on the thickness of the foam slab that will run through it.

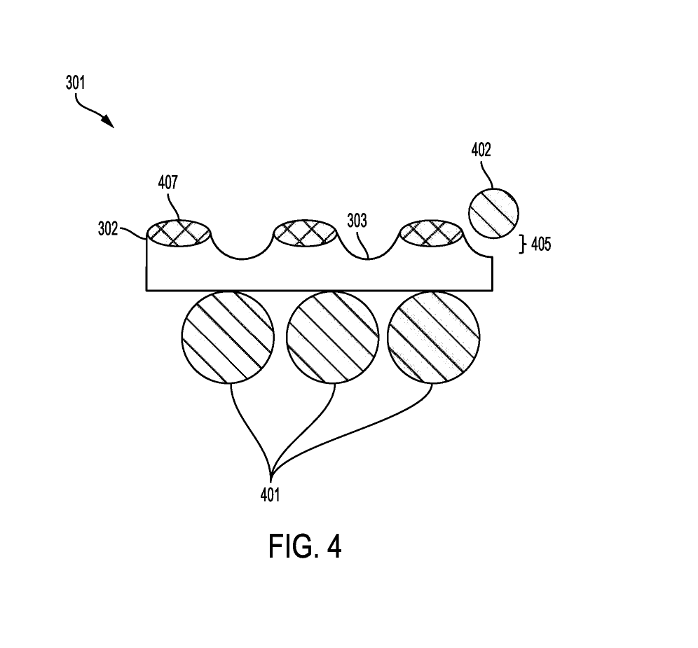

FIG. 4 illustrates how a roll coating system may apply the temperature regulating material to the temperature regulating zones of the foam bedding product. Using the foam sheet 301 from FIG. 3, the roll coating system includes one or more support rollers 401 that are positioned to support the foam sheet 301, and one or more applicator rollers 402 that contain the temperature regulating material and transfer it to the foam sheet 301 when the foam sheet passes under and contacts the applicator roller(s) 402. The applicator rollers 402 are positioned a distance above the valleys 303 of the foam sheet to provide a gap 405, so that when the applicator rollers touch the peaks 302 of the sheet they will contact and transfer material to the peaks 302 but not contact the valleys 303. The temperature regulating material 407 will sit on top of and/or soak into the tops of the peaks 302 while remaining out of the valleys. (When this document uses phrases such as “remaining out of the valleys” or “free from the temperature regulating material,” it includes embodiments where an insignificant amount of the material enters the valleys due to drips, absorption and spreading, force of gravity and the like.

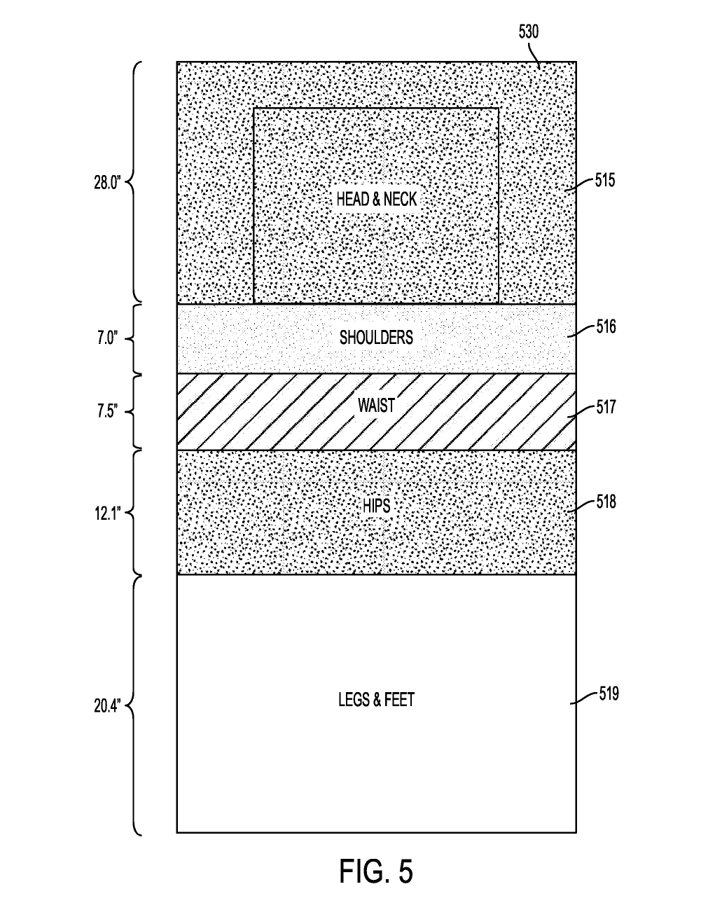

Optionally, the roll coating system may include a processor and programming instructions, and/or manual controls, that are configured to raise and lower the applicator rollers(s) to more selectively apply the temperature regulating material. For example, referring to FIG. 5, the bedding product 530 may be a mattress or mattress topper that includes five (or any number of) temperature regulation zones or divisions 515-519, each of which is configured to correspond to (i.e., be positioned under) an area of the body of a person who is reclining on the bedding product: Head/Neck 515, Shoulders 516, Waist 517, Hips 518, and Legs/Feet 519. The system may include a user interface that receives as input a definition of a zone that it will use to determine a distance between the applicator roller and the support roller as the corresponding zone passes between the rollers.

For example, the system may be programmed, or the user interface may accept commands, to cause the rollers to be closer together when the Head/Neck 515 and Hips 518 zones pass between the rollers, thus depositing a relatively high amount of temperature regulating material on the peaks of the foam sheet in those zones. When the Legs/Feet zone 519 passes between the rollers, the commands may cause the applicator roller to move away from the support rollers so that it does not touch or apply any temperature regulating material to the foam, or it may slightly touch the foam so that it only transfers a very small amount of material to the foam. When the Shoulders 516 and Waist 517 zones pass through the rollers, different settings may be used, such as a gap distance that is less than that used for the Legs/Feet zone 519 but more than that used for the Head/Neck zone 515, thus yielding a moderate application of temperature regulating material to the peaks of those zones of the foam bedding product. In this way, some of the zones (e.g., Head/Neck and Hips, and optionally Shoulders and Waist) may be considered temperature regulating zones in that they include the temperature regulating material, while other zones (e.g., Legs/Feet) may not provide any temperature regulation properties other than those already inherent in the foam without any additional material applied thereon.

The embodiments described herein are not limited to this particular configuration of zones and divisions. Instead, a variety of zones and arrangements thereof is possible. The size of the zones shown in FIG. 5 may be determined using human anthropometric data. For example, the person may be selected as one of typical size and height for a human adult, or one representing a range of adult sizes and heights, such as adults ranging from 5′-0″ in size to 6′-0″ in height, 5′-2″ to 6′-2″ in height, or any other suitable range. Example sizes for the zones are shown in FIG. 5, although other sizes are possible. In this embodiment, the number of divisions (five) is by way of example, and the sizes shown may vary by, for example, plus or minus 1 inch, 2 inches, 3 inches and other values.

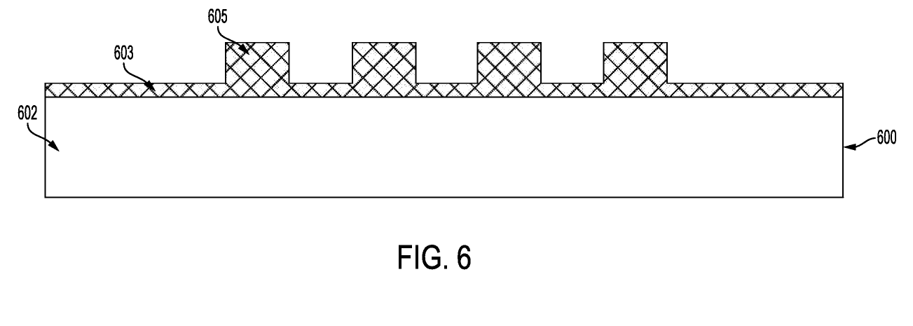

FIG. 6 illustrates an alternate embodiment of a bedding product with temperature regulating raised sections 605. In the example bedding product, raised sections 605 are added to the support layer 600 and the temperature regulating material 603 is dispersed within at least a portion of the raised sections 605 as well as on top of the support layer. Substrate material 602 is distributed throughout the support layer 600.

In an alternate embodiment, the temperature regulating zones include channels (i.e., valleys) that are formed into the support layer and filled with temperature regulating material. Temperature regulating material may be dispersed into the channels utilizing a variety of techniques or processes as is known in the art (e.g., as an additive or component or the like during any stage of manufacturing the bedding product), such as roll-coating, etc. The porous nature of the foam may enable the temperature regulating material to penetrate and be at least partially absorbed into the surface.

In a particular embodiment of the present disclosure, the depth of the channels may be between about 0.05 inch and about 1 inch. In another particular embodiment, the depth of the channels is about 0.05 inch, about 0.2 inches, about 0.5 inches, about 0.75 inches or about 1 inch. In another particular embodiment, the depth of the channels is any fraction of an inch. Different channels may have different depths. Other sizes are possible.

Similarly, in a particular embodiment of the present disclosure, the width of the channel may be between about 1 inch and about 5 inches. In another particular embodiment, the width of the channels is about 1 inch, about 2 inches, about 3 inches, about 4 inches or about 5 inches. In another particular embodiment, the width of the channels is a fraction of an inch. Other sizes are possible. Different channels may have different widths. Wider widths may allow more temperature regulating material to be distributed to the substrate in those areas. A single bedding product may have channels of various widths in order to provide multiple, varied thermal patterns in body-contacting surface of the bedding product.

The channels can be formed by molding, cutting, digging trenches into, routing, using surface modification techniques on, convoluting, compression cutting or otherwise working the support layer. When the temperature controlling material is applied to the support layer, it will fill the channels and thus have a greater thickness in the channels than in other areas of the support layer. Optionally, the temperature controlling material may be applied only or substantially only to the channels. This can help concentrate the temperature controlling material in the temperature regulating areas.

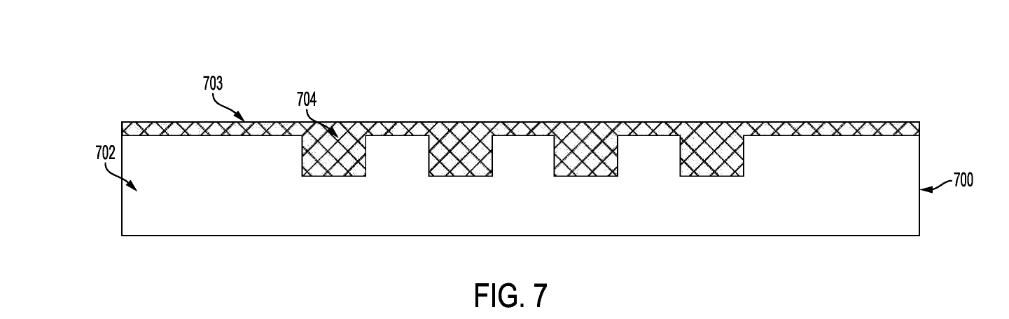

FIG. 7 illustrates a bedding product with channels 704 formed into the support layer 700. In the example bedding product, the support layer 700 includes substrate material 702. The channels 704 are formed into the support layer 700, and temperature regulated material 703 is applied to the channels 704, creating temperature regulated channels 704.

Some embodiments of the present disclosure are directed to a method for fabricating a bedding product with a zoned temperature regulating system. In one particular embodiment, the method includes (a) providing a support layer comprising substrate material; (b) forming a plurality of channels into the support layer, wherein the channels are arranged in temperature regulating zones that come in contact with parts of the body selected from the group consisting of the head, torso, buttocks, legs, feet, and any combination thereof; and (c) dispersing temperature regulating material throughout and within the channels so that the temperature regulating material has a thickness that is larger in the channels than on any other surface of the support layer.

In a more particular method, the substrate material is conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam, or combinations thereof, and the temperature regulating material is gel or gel-foam.

In another particular embodiment, the method includes (a) providing a support layer comprising substrate material; (b) forming a plurality of raised sections on the support layer, wherein the raised sections are arranged in temperature regulating zones that come in contact with parts of the body selected from the group consisting of the head, torso, buttocks, legs, feet, and any combination thereof; and (c) selectively applying temperature regulating material to the raised sections without applying the temperature regulating material to at least a majority of the surface area that does not include the raised sections.

In another embodiment, the method includes (a) providing a support layer comprising a substrate material; and (b) adhering a plurality of raised sections comprising temperature controlling material to the substrate in one or more areas that correspond to temperature regulating zones.

Although the present invention has been described in considerable detail with reference to certain preferred embodiments thereof, other versions are possible. Therefore the spirit and scope of the invention should not be limited to the description and the various specific examples described within this specification.

1. A bedding product comprising:
a support layer comprising substrate material having a plurality of peaks and valleys arranged thereon; and
temperature regulating material, wherein the temperature regulating material is disposed on the peaks or valleys in one or more temperature regulating zones along an upper surface of the support layer, while areas of the support layer that do not correspond to temperature regulating zones are free from the temperature regulating material or have a lesser amount the temperature regulating material applied thereto.

2. The bedding product of claim 1, wherein:
the temperature regulating material comprises gel or gel foam; and
the substrate material comprises conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam, or combinations thereof.

3. The bedding product of claim 2, wherein the temperature regulating zones are positioned so that the temperature regulating zones coming into contact with at least one, but less than all, of the following parts of the body of a typical human user during use: head/neck, shoulders, waist, hips, and legs/feet.

4. The bedding product of claim 3, wherein the temperature regulating zones comprise raised sections having peaks that comprise the temperature regulating material.

5. The bedding product of claim 5, wherein the temperature regulating zones also comprise valleys that are free from the temperature regulating material.

6. The bedding product of claim 3, wherein the temperature regulating zones comprise channels formed into the support layer and at least partially filled with the temperature regulating material.

7. A method for fabricating a bedding product with a zoned temperature regulating system, comprising:
providing a support layer comprising a foam substrate material;
forming a plurality of peaks and valleys into the support layer, wherein the peaks and valleys are selectively arranged in temperature regulating zones; and
dispersing temperature regulating material onto the peaks or valleys of one or more of the temperature regulating zones along an upper surface of the support layer, so that areas of the support layer that do not correspond to temperature regulating zones are free from the temperature regulating material or have a lesser amount the temperature regulating material applied thereto.

8. The method of claim 7, wherein forming the plurality of peaks and valleys into the support layer comprises, by a convoluter having a blade and a plurality of patterned rollers:
drawing the support layer across the blade to split the support layer; and
using the patterned rollers to impart the peaks and valleys on the support layer.

9. The method of claim 7, wherein forming the plurality of peaks and valleys into the support layer comprises, by a compression cutter:
compressing the support layer against a board that bears a pattern to form peaks and valleys in the support layer; and
cutting material from the support layer in compressed sections of the support layer.

10. The method of claim 7, wherein dispersing the temperature regulating material comprises:
by one or more support rollers of a roll coater, drawing the support layer between an applicator roller and the one or more support rollers so that the applicator roller applies the temperature regulating material to the peaks of one or more of the temperature regulating zones but does not apply the temperature regulating material to the valleys of the temperature regulating zones.

11. The method of claim 10, wherein dispersing the temperature regulating material also comprises operating the roll coater so that:
the applicator roller contacts the peaks when the temperature regulating zones pass through a gap between the applicator roller and the support rollers; and
when a portion of the support layer that does not include a temperature regulating zone passes through the gap, the applicator roller is moved away from the support rollers to expand the gap so that the applicator roller does not contact the portion of the support layer that does not include a temperature regulating zone.

12. The method of claim 11, wherein dispersing the dispersing the temperature regulating material also comprises operating the roll coater so that:
the applicator roller is positioned to cause the gap to have a first size when a first one of the temperature regulating zones passes through the gap; and
the applicator roller is positioned to cause the gap to have a second size when a second one of the temperature regulating zones passes through the gap, wherein the second size is larger than the first size but the applicator roller will still contact the peaks when the second temperature regulating zone passes through the gap.

13. The method of claim 12, wherein:
the first temperature regulating zone corresponds to a head/neck area or a waist area of the support layer, and
the second temperature regulating zone corresponds to a legs/feet area of support layer.

14. The method of claim 7, wherein the substrate material comprises conventional foam, high resilience foam, latex foam rubber, viscoelastic foam, polyurethane foam, memory foam, slow recovery foam, ground foam, latex foam, reflex foam, continuous foam, hyper-soft resilient foam, hyper-soft high airflow viscoelastic foam, or combinations thereof.

15. The method of claim 7, wherein the temperature regulating material comprises gel or gel-foam.

16. A method for fabricating a bedding product with a zoned temperature regulating system, comprising:
providing a support layer comprising a foam substrate material;
forming a plurality of peaks and valleys into the support layer; and
by a roll coating device, dispersing temperature regulating material onto the peaks or valleys of one or more temperature regulating zones along an upper surface of the support layer, so that areas of the support layer that do not correspond to temperature regulating zones are free from the temperature regulating material or have a lesser amount the temperature regulating material applied thereto.

17. The method of claim 16, wherein dispersing the temperature regulating material comprises:
by one or more support rollers of the roll coating device, drawing the support layer between an applicator roller and the one or more support rollers so that the applicator roller applies the temperature regulating material to the peaks of one or more of the temperature regulating zones but does not apply the temperature regulating material to the valleys of the temperature regulating zones.

18. The method of claim 16, wherein dispersing the temperature regulating material also comprises operating the roll coating device so that:
the applicator roller contacts the peaks when the temperature regulating zones pass through a gap between the applicator roller and the support rollers; and
when a portion of the support layer that does not include a temperature regulating zone passes through the gap, the applicator roller is moved away from the support rollers to expand the gap so that the applicator roller does not contact the portion of the support layer that does not include a temperature regulating zone.

19. The method of claim 18, wherein dispersing the temperature regulating material also comprises operating the roll coating device so that:
the applicator roller is positioned to cause the gap to have a first size when a first one of the temperature regulating zones passes through the gap; and
the applicator roller is positioned to cause the gap to have a second size when a second one of the temperature regulating zones passes through the gap, wherein the second size is larger than the first size but the applicator roller will still contact the peaks when the second temperature regulating zone passes through the gap.

20. The method of claim 16, wherein:
the first temperature regulating zone corresponds to a head/neck area or a waist area of the support layer, and
the second temperature regulating zone corresponds to a legs/feet area of support layer.
